(19) United States
(12) Patent Application Publication
(10) Pub. No.: US 2019/0010953 A1
(43) Pub. Date: Jan. 10, 2019

(54) VANE WHEEL AND BLOWING DEVICE

(71) Applicant: Nidec Corporation, Kyoto (JP)

(72) Inventor: Masashi TAKAO, Kyoto (JP)

(21) Appl. No.: 15/985,742

(22) Filed: May 22, 2018

(30) Foreign Application Priority Data
Jul. 5, 2017 (JP) 2017-131826

(51) Int. Cl. F04D 29/26; F04D 29/24; F04D 29/62; F04D 17/08

(52) U.S. Cl. CPC F04D 29/263; F04D 29/242; F04D 29/626; F04D 17/08; F05D 2250/711; F05D 2240/30; F05D 2240/60; F05D 2250/131; F05D 2250/232; F05D 2240/14

(57) ABSTRACT

A vane wheel includes a shaft and an impeller. The shaft is disposed along a center axis and is circular in plan view from an axial direction. The impeller includes an impeller cylinder portion to which one end portion of the shaft in the axial direction is fixed. The impeller cylinder portion includes a plurality of first portions and second portions on an inner circumferential surface of the impeller cylinder portion. The first portions are disposed with an interval in a circumferential direction, and are in contact with the shaft and fix the shaft. The second portions face the shaft with an interval in a radial direction, and each of the second portions is positioned between two of the first portions which are adjacent in the circumferential direction.

### CROSS REFERENCE TO RELATED APPLICATIONS

This application claims the benefit of priority to Japanese Patent Application No. 2017-131826 filed on Jul. 5, 2017. The entire contents of this application are hereby incorporated herein by reference.

### FIELD OF THE INVENTION

The present disclosure relates to a vane wheel and a blowing device.

### DESCRIPTION OF THE RELATED ART

Japanese Unexamined Patent Application Publication No. 2015-140796 discloses an electric blower capable of reliably rotation locking a centrifugal fan with respect to a rotation shaft without reducing a rotation balance. The electric blower includes a centrifugal fan which rotates by the rotation of a rotation shaft of a rotor of a brushless motor. The centrifugal fan is provided with a cylindrical fan main body having an insertion hole into which the rotation shaft, which penetrates a center portion, is inserted. The centrifugal fan is provided with a groove portion which is provided along an axial direction of the fan main body inside the insertion hole to communicate with one end side of the insertion hole and does not communicate with the other end side of the insertion hole. The electric blower includes a rotation locking unit which is formed of a resin material and rotation locks the rotation shaft and the centrifugal fan in a circumferential direction by being adhered to an outer circumferential surface of the rotation shaft to be fitted into the groove portion.

In recent years, there is increased demand for causing a centrifugal fan of an electric blower to rotate at high speed. In a configuration in which the centrifugal fan is fixed to the rotation shaft using a resin material, there is a possibility that durability during high-speed rotation is not sufficient. For example, by adopting a configuration in which the rotation shaft is firmly press-fitted to the centrifugal fan, it is possible to improve the durability during the high-speed rotation. However, in the configuration, for example, in which the rotation shaft is firmly press-fitted to the centrifugal fan, there is a possibility that cracks will be generated in the centrifugal fan during manufacturing.

### SUMMARY OF THE INVENTION

Accordingly, it is an object of the present disclosure to provide a technology capable of suppressing the generation of cracks in an impeller.

An exemplary vane wheel of the present disclosure includes a shaft and an impeller. The shaft is disposed along a center axis and is circular in plan view from an axial direction. The impeller includes an impeller cylinder portion to which one end portion of the shaft in the axial direction is fixed. The impeller cylinder portion includes a plurality of first portions and second portions on an inner circumferential surface of the impeller cylinder portion. The first portions are disposed with an interval in a circumferential direction, and are in contact with the shaft and fix the shaft. The second portions face the shaft with an interval in a radial direction, and each of the second portions is positioned between two of the first portions which are adjacent in the circumferential direction.

An exemplary blowing device of the present disclosure includes the vane wheel.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a vacuum cleaner according to an embodiment of the present disclosure.

FIG. 2 is a perspective view of a blowing device according to the embodiment of the present disclosure.

FIG. 3 is a vertical sectional view of the blowing device according to the embodiment of the present disclosure.

FIG. 4 is a perspective view of a vane wheel according to the embodiment of the present disclosure.

FIG. 5 is a vertical sectional view of the vane wheel according to the embodiment of the present disclosure.

FIG. 6 is a lateral sectional view illustrating a relationship between an impeller cylinder portion and a shaft.

FIG. 7 is a schematic view illustrating a configuration of one end portion of the shaft.

FIG. 8 is a diagram for explaining a first modification example of the vane wheel according to the embodiment of the present disclosure.

FIG. 9 is a diagram for explaining a second modification example of the vane wheel according to the embodiment of the present disclosure.

FIG. 10 is a diagram for explaining a third modification example of the vane wheel according to the embodiment of the present disclosure.

FIG. 11 is a diagram for explaining a fourth modification example of the vane wheel according to the embodiment of the present disclosure.

### DETAILED DESCRIPTION OF THE PREFERRED EMBODIMENTS

Hereinafter, a detailed description will be given of the exemplary embodiments of the present disclosure with reference to the drawings. In this specification, in a vane wheel 1 and a blowing device 100, a direction parallel to a center axis C of the vane wheel 1 is referred to as an “axial direction”, a direction orthogonal to the center axis C of the vane wheel 1 is referred to as a “radial direction”, and a direction going along an arc centered on the center axis C of the vane wheel 1 is referred to as a “circumferential direction”.

In this specification, a description will be given of shapes and positional relationships of respective parts in the blowing device 100 where the axial direction is an up-down direction and the side of an impeller 11 is up with respect to a motor 2. The up-down direction is a name simply used for explanation and does not restrict the actual positional relationships and directions.

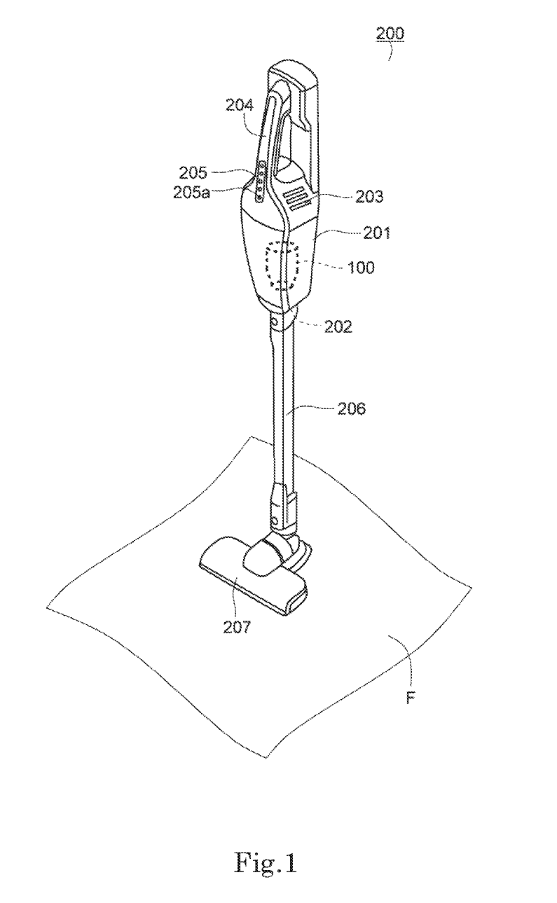

In this specification, a description will be given of shapes and positional relationships of respective parts in a vacuum cleaner 200 where a direction approaching a floor surface F (a cleaning target surface) of FIG. 1 is “downward” and a direction separating from the floor surface F is “upward”. These directions are names simply used for explanation and do not restrict the actual positional relationships and directions.

The terms “upstream” and “downstream” indicate the upstream and the downstream in a flow direction of air which is sucked in from a gas inlet 102 when the vane wheel 1 is rotated.

Hereinafter, a description will be given of the vacuum cleaner on which the blowing device 100 having the vane wheel 1 of the exemplary embodiment of the present disclosure is mounted. FIG. 1 is a perspective view of the vacuum cleaner 200 according to an embodiment of the present disclosure. The vacuum cleaner 200 is a stick type electric vacuum cleaner. The vacuum cleaner 200 includes a casing 201 which is provided with a gas suction portion 202 and a gas discharging portion 203 on the bottom surface and the top surface, respectively. A power cord (not illustrated) is routed out from the rear surface of the casing 201. The power cord is connected to a power outlet (not illustrated) which is provided on a side wall surface of a room and supplies power to the vacuum cleaner 200. The vacuum cleaner 200 may be a robot type, a canister type, or a handy type electric vacuum cleaner.

An air path (not illustrated) which communicates the gas suction portion 202 with the gas discharging portion 203 is formed inside the casing 201. A waste collection unit (not illustrated), a filter (not illustrated), and the blowing device 100 are disposed in order from the upstream side toward the downstream side inside the air path. Refuse such as dust contained in the air which flows inside the air path is captured by the filter and collected inside the waste collection unit which is formed in a container shape. The waste collection unit and the filter are configured to be attachable to and detachable from the casing 201.

A grip portion 204 and an operation portion 205 are provided on the top portion of the casing 201. The user is capable of gripping the grip portion 204 and moving the vacuum cleaner 200. The operation portion 205 includes a plurality of buttons 205a. The user performs operation settings of the vacuum cleaner 200 by operating the buttons 205a. For example, driving start, driving stop, modifying revolution rate and the like of the blowing device 100 are instructed by the operation of the buttons 205a. A rod-shaped suction tube 206 is connected to the gas suction portion 202. A suction nozzle 207 is attached to the upstream end of the suction tube 206 to be attachable to and detachable from the suction tube 206. The upstream end of the suction tube 206 is the bottom end of the suction tube 206 in FIG. 1.

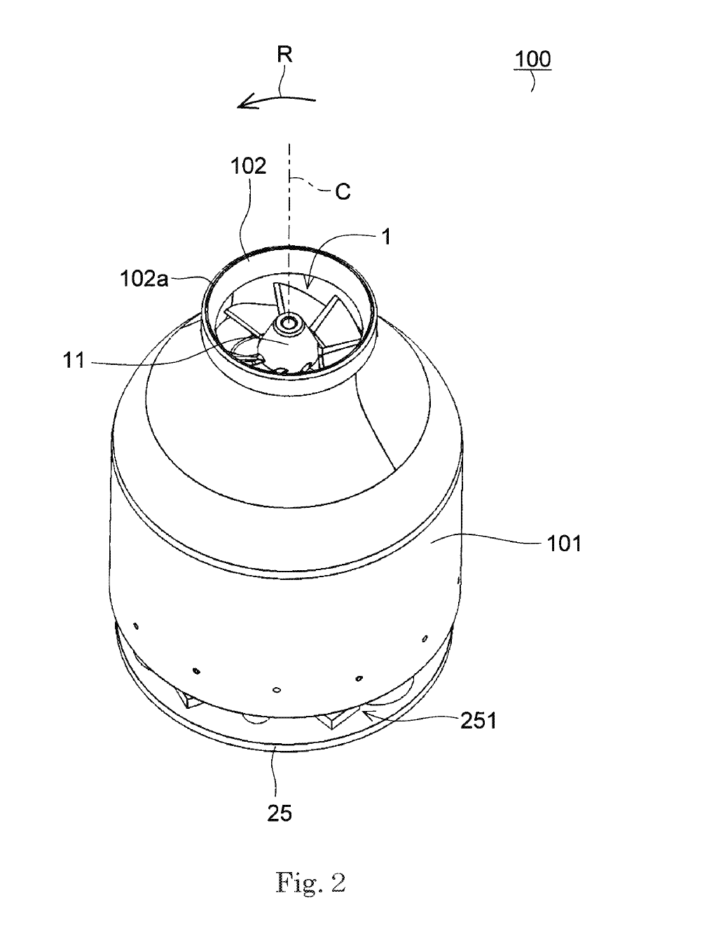

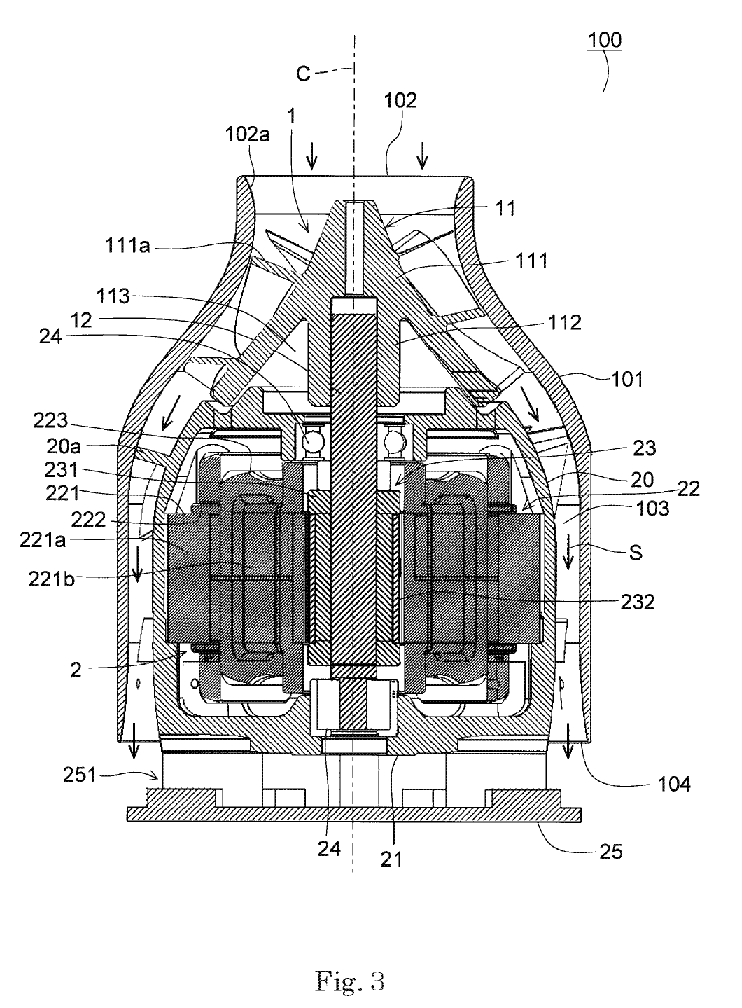

FIG. 2 is a perspective view of the blowing device 100 according to the embodiment of the present disclosure. FIG. 3 is a vertical sectional view of the blowing device 100 according to the embodiment of the present disclosure. The blowing device 100 is mounted on the vacuum cleaner 200 and sucks the air. The blowing device 100 includes the vane wheel 1.

The blowing device 100 includes a cylindrical fan casing 101, the horizontal cross-section of which is circular. The vane wheel 1 and the motor 2 are stored in the fan casing 101. The gas inlet 102 which is open in the up-down direction is provided in the top portion of the fan casing 101. A bellmouth 102a which is inclined from the top end to the inside in the radial direction and extends downward is provided on the gas inlet 102. Accordingly, the diameter of the gas inlet 102 smoothly decreases in size going from the top toward the bottom. The bottom surface of the fan casing 101 is open in the up-down direction.

The vane wheel 1 which includes the impeller 11 is joined to the motor 2 which is disposed under the impeller 11. According to driving of the motor 2, the vane wheel 1 rotates centered on the center axis C which extends vertically. In the present embodiment, the vane wheel 1 rotates in a rotation direction R illustrated in FIG. 2. A detailed description of the vane wheel 1 will be given later.

The motor 2 includes a cylindrical motor housing 20, the horizontal cross-section of which is circular. A flow path 103 is formed in the gap between the fan casing 101 and the motor housing 20. The flow path 103 communicates with the impeller 11 on the top end (the upstream end) and an exhaust port 104 is formed in the bottom end (the downstream end) of the flow path 103. A disc-shaped bottom cover 21 is disposed under a stator 22 (described later). The bottom surface of the motor housing 20 is covered by the bottom cover 21. The bottom cover 21 is attached to the motor housing 20 using a screw (not illustrated).

A plurality of stator blades 20a are provided on an outer circumferential surface of the motor housing 20 to line up in the circumferential direction. The stator blades 20a are configured to be plate-shaped. The stator blades 20a are inclined toward the direction opposite from the rotation direction R of the vane wheel 1 while going upward. The stator blades 20a are curved such that the top sides are convex. The outside edges of the plurality of stator blades 20a are in contact with the inner surface of the fan casing 101. The stator blades 20a guide an airflow downward as illustrated by an arrow S using the driving of the blowing device 100.

The motor 2 is an inner rotor type motor and includes the stator 22, a rotor 23, bearing portions 24, and a circuit board 25.

The stator 22 is disposed on the outside of the rotor 23 in the radial direction. The stator 22 includes a stator core 221 and an insulator 222. The stator core 221 consists of a laminated steel plate in which electromagnetic steel plates are laminated in the axial direction. The stator core 221 includes an annular core back 221a and a plurality of teeth 221b. The plurality of teeth 221b are formed to extend radially inward in the radial direction from an inner circumferential surface of the core back 221a. The plurality of teeth 221b are arranged at an equal interval in the circumferential direction.

The insulator 222 is composed of an insulating material such as a resin and covers at least a portion of the stator core 221. A coil 223 is configured by winding a conducting wire around the teeth 221b with the insulator 222 in between. In other words, the insulator 222 is disposed between the coil 223 and the teeth 221b. The teeth 221b and the coil 223 are insulated by the insulator 222.

The rotor 23 includes a cylindrical rotor housing 231 and a plurality of magnets 232. The rotor housing 231 holds a shaft 12 of the vane wheel 1. The plurality of magnets 232 are disposed on an outer circumferential surface of the rotor housing 231. The surface on the outside of each of the magnets 232 in the radial direction faces the end surface of the inside of each of the teeth 221b in the radial direction. The plurality of magnets 232 are disposed at an equal interval in the circumferential direction such that N pole magnetic surfaces and S pole magnetic surfaces are lined up alternately. A single ring-shaped magnet may be used instead of the plurality of magnets 232. In this case, an outer circumferential surface of the magnet may be magnetized such that the N pole and the S pole alternate in the circumferential direction. The magnet and the rotor housing may be formed integrally using a resin which is combined with a magnetic powder.

The shaft 12 which is held by the rotor housing 231 is supported by the upper and lower bearing portions 24 to be rotatable and rotates together with the rotor 23 centered on the center axis C. The rotation direction is the rotation direction R illustrated in FIG. 2. The upper bearing portion 24 is supported by the center portion of the top portion of the motor housing 20. The lower bearing portion 24 is supported by the center portion of the bottom cover 21. In the present embodiment, the upper bearing portion 24 includes ball bearings and the lower bearing portion 24 includes a slide bearing. The upper and lower bearing portions 24 may include other types of bearing. For example, the upper and lower bearing portions 24 may both include ball bearings.

The circuit board 25 is disposed under the bottom cover 21. The circuit board 25 is circular and is formed of a resin such as an epoxy resin, for example. Electronic components 251 are disposed on the circuit board 25. The electronic components 251 include an AC/DC converter, an inverter, a control circuit, and the like. The circuit board 25 is electrically connected to the stator 22 by a connection terminal (not illustrated). Alternating current power which is supplied from a commercial power source is transformed into direct current power and the motor 2 is driven by the power being supplied to the coil 223 via the inverter. The blowing device 100 causes the vane wheel 1 to rotate using the driving of the motor 2 and generates an airflow.

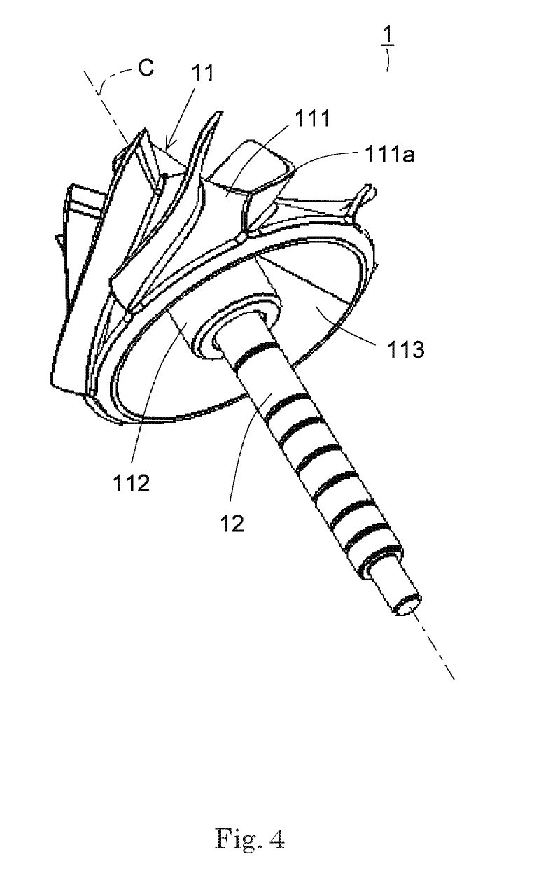

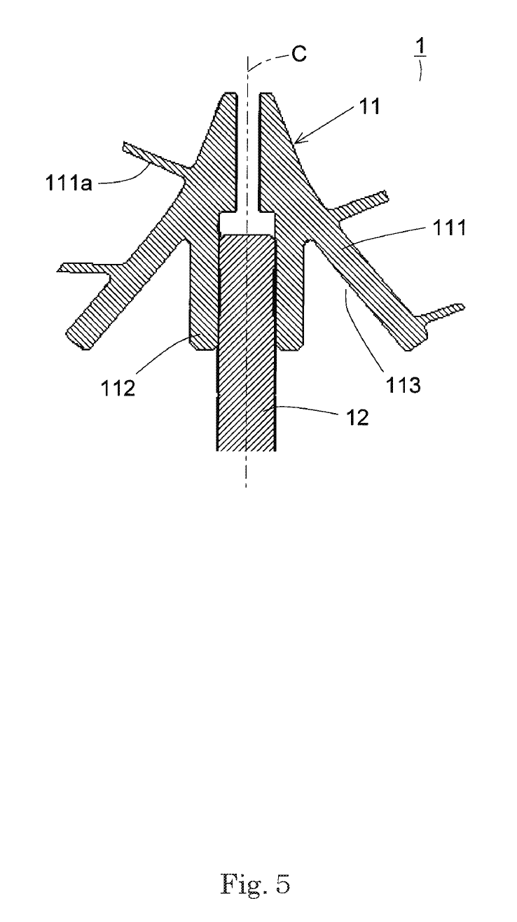

FIG. 4 is a perspective view of the vane wheel 1 according to the embodiment of the present disclosure. FIG. 5 is a vertical sectional view of the vane wheel 1 according to the embodiment of the present disclosure. FIG. 5 illustrates a portion of the vane wheel 1. As illustrated in FIGS. 4 and 5, the vane wheel 1 includes the shaft 12 and the impeller 11.

The shaft 12 is disposed along the center axis C. The shaft 12 is circular in plan view from the axial direction. The shaft 12 is a rod-shaped member made of metal. In the present embodiment, the shaft 12 is made of stainless steel. The shaft 12 may be columnar or cylindrical.

The impeller 11 is a diagonal flow impeller. In the present embodiment, the impeller 11 is formed by casting using an aluminum alloy. However, the impeller 11 may be formed using other metals. The impeller 11 is not limited to being made of metal and may be made of a resin. It is preferable for the impeller 11 to be a cast product in order to improve the durability during high-speed rotation. The impeller 11 includes an impeller base portion 111, an impeller cylinder portion 112, and a gap portion 113.

The impeller base portion 111 includes a plurality of vanes 111a on an outer circumferential surface. In the present embodiment, the impeller base portion 111 is conical. In detail, the diameter of the impeller base portion 111 increases in size going downward. The bottom end portion of the impeller base portion 111 is open. The shape of the opening is circular in plan view from the axial direction. Truncated cone-shaped may be included in the definition of conical. As illustrated in FIG. 3, in the blowing device 100, the top end portion of the impeller base portion 111 is disposed at approximately the same height as the bottom end of the bell mouth 102a. The plurality of vanes 111a are disposed to line up in the circumferential direction on the outer circumferential surface of the impeller base portion 111. In each of the vanes 111a, the top portion of the vane 111a is positioned in front of the bottom portion of the vane 111a in the rotation direction R.

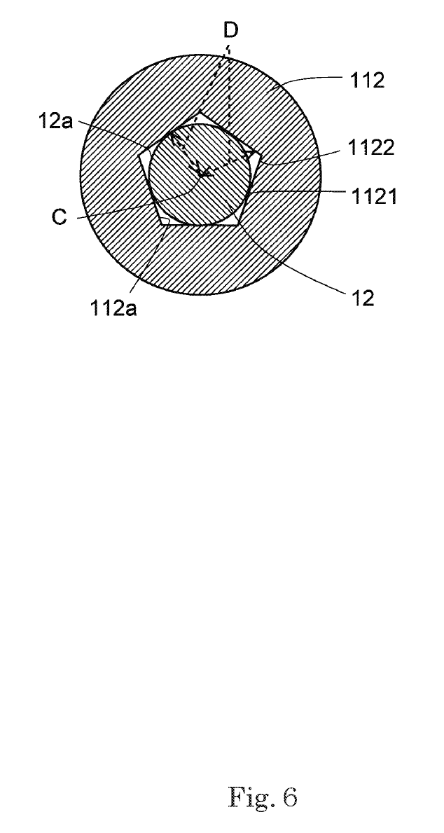

The impeller cylinder portion 112 is positioned inside the impeller base portion 111 in the radial direction. One end portion of the shaft 12 is fixed to the impeller cylinder portion 112. In the present embodiment, the top end portion of the shaft 12 is fixed to the impeller cylinder portion 112. FIG. 6 is a lateral sectional view illustrating a relationship between the impeller cylinder portion 112 and the shaft 12.

As illustrated in FIG. 6, the impeller cylinder portion 112 has a circular external shape in plan view from the axial direction. However, the external shape of the impeller cylinder portion 112 is not limited to being circular in plan view from the axial direction and may be another shape. The external shape of the impeller cylinder portion 112 may be polygonal, elliptical, or the like, for example, in plan view from the axial direction. It is possible to reduce air resistance by rendering the external shape of the impeller cylinder portion 112 circular.

As illustrated in FIG. 6, the impeller cylinder portion 112 includes a plurality of first portions 1121 and a plurality of second portions 1122 on an inner circumferential surface 112a. The plurality of first portions 1121 are disposed with an interval in the circumferential direction and are in contact with the shaft 12 to fix the shaft 12. The plurality of second portions 1122 face the shaft 12, with an interval therebetween in the radial direction, and each is positioned between two of the first portions 1121 which are adjacent in the circumferential direction. In other words, one second portion 1122 is positioned between two of the first portions 1121 which are adjacent in the circumferential direction.

In this configuration, in the circumferential direction, a portion of an outer circumferential surface 12a of the shaft 12 is caused to come into contact with the inner circumferential surface 112a of the impeller cylinder portion 112 to fix the shaft 12 to the impeller cylinder portion 112. In this configuration, in the circumferential direction, the impeller cylinder portion 112 includes a portion which is separated from the shaft 12 in the radial direction. Since the portion which is separated from the shaft 12 in the radial direction is easily deformed, in this configuration, it is possible to distribute the force which is applied to the impeller cylinder portion 112 from the shaft 12. In other words, in this configuration, it is possible to reduce the generation of cracks in the impeller 11 in comparison to a case in which the inner circumferential surface of the impeller cylinder portion is provided to be circular and the entire circumference of the outer circumferential surface of the shaft 12 is caused to contact the inner circumferential surface of the impeller cylinder portion to fix the shaft 12. Since it is possible to suppress the generation of cracks in the impeller 11 during the manufacturing, it is possible to efficiently manufacture the blowing device 100 which includes the vane wheel 1 of the present embodiment.

In the present embodiment, the shaft 12 is press-fitted to the plurality of first portions 1121. In other words, the first portions 1121 are zones in which the shaft 12 is pressed into the impeller cylinder portion 112. The second portions 1122 are zones in which the shaft 12 is not pressed into the impeller cylinder portion 112. The plurality of first portions 1121 are disposed at a substantially equal interval in the circumferential direction. Each of the plurality of second portions 1122 is interposed between two of the first portions 1121 which are adjacent in the circumferential direction. The shaft 12 is fixed through strong pressing into the plurality of first portions 1121 since it is necessary to firmly hold the impeller 11 which rotates at high speed. The impeller 11 rotates at a rotation speed of greater than or equal to 100,000 rpm, for example.

In the present embodiment, the shaft 12 is press-fitted to a portion of the inner circumferential surface 112a of the impeller cylinder portion 112 in the circumferential direction and is not in contact with the remaining portions. Therefore, in a case in which the shaft 12 is pressed into the impeller cylinder portion 112, it is possible to distribute the pressing stress which is generated in the impeller cylinder portion 112 and it is possible to suppress the generation of cracks in the impeller 11 using the pressing of the shaft 12.

In the present embodiment, although a configuration is adopted in which the shaft 12 is pressed into the impeller cylinder portion 112, the configuration is not limited thereto. For example, a configuration may be adopted in which the shaft 12 is fixed to the impeller cylinder portion 112 using shrink fitting. In the shrink fitting, the impeller cylinder portion 112 is heated and the shaft 12 is inserted into a hole of the impeller cylinder portion 112 which is expanded by the heating. The shaft 12 is fixed to the impeller cylinder portion 112 by the thermal contraction which accompanies the cooling of the impeller cylinder portion 112. Even in the case of shrink fitting, it is possible to distribute the force which is applied to the impeller cylinder portion 112 from the shaft 12 using the presence of the portions which are separated from the shaft 12 in the radial direction. Therefore, it is possible to suppress the generation of cracks in the impeller 11 when fixing the shaft 12 to the impeller cylinder portion 112.

In the present embodiment, the inner circumferential surface 112a of the impeller cylinder portion 112 is polygonal or elliptical in plan view from the axial direction. The shapes of the parts to which the shaft 12 is fixed in the inner circumferential surface 112a of the impeller cylinder portion 112 are the same shape from the top end to the bottom end. The first portion 1121 includes a portion of the inner circumferential surface 112a of the impeller cylinder portion 112 at which a radial direction distance D from the center axis C is minimal. In this configuration, the shape of the inner circumferential surface 112a of the impeller cylinder portion 112 does not easily become complicated and it is possible to render the manufacturing of the vane wheel 1 simple.

In the present embodiment, in detail, the inner circumferential surface 112a of the impeller cylinder portion 112 is pentagonal in plan view from the axial direction. However, the inner circumferential surface 112a of the impeller cylinder portion 112 is not limited to being pentagonal and may be another polygonal shape such as a triangle. In more detail, the inner circumferential surface 112a of the impeller cylinder portion 112 is a regular pentagon in plan view from the axial direction. By adopting a regular pentagon shape, it is possible to easily obtain a balance during the rotation of the impeller 11. It is possible to equally distribute the force which is applied to the impeller cylinder portion 112 from the shaft 12. The first portions 1121 include the center point position of each side of the regular pentagon. In other words, there are five of the first portions 1121. The second portions 1122 include peak portions of the regular pentagon. In a case in which the inner circumferential surface 112a of the impeller cylinder portion 112 is polygonal, the peak portions of the polygon are not necessarily pointed and may be rounded off. The lines which join the adjacent peak portions of the polygon are not necessarily straight lines and may be curved.

As illustrated in FIGS. 4 and 5, the gap portion 113 is positioned between the impeller base portion 111 and the impeller cylinder portion 112 in the radial direction. The width of the gap portion 113 in the radial direction becomes gradually smaller from the bottom toward the top of the impeller cylinder portion 112. At least a portion of one end portion of the shaft 12 which is fixed to the impeller cylinder portion 112 faces the impeller base portion 111 with the gap portion 113 in between. It is favorable for the entirety of the one end portion of the shaft 12 which is fixed to the impeller cylinder portion 112 to face the impeller base portion 111 with the gap portion 113 in between. In the present embodiment, the majority of the one end portion of the shaft 12 which is fixed to the impeller cylinder portion 112 faces the impeller base portion 111 in the radial direction with the gap portion 113 in between.

In this configuration, at least a portion of the zone in which the shaft 12 and the impeller cylinder portion 112 contact each other in the axial direction due to the pressing faces the impeller base portion 111 in the radial direction with the gap portion 113 in between. Therefore, it is possible to suppress the force which is applied from the shaft 12 to the impeller cylinder portion 112 to be transmitted to the impeller base portion 111. Accordingly, it is possible to prevent the deformation of the vanes 111a which are provided on the impeller base portion 111.

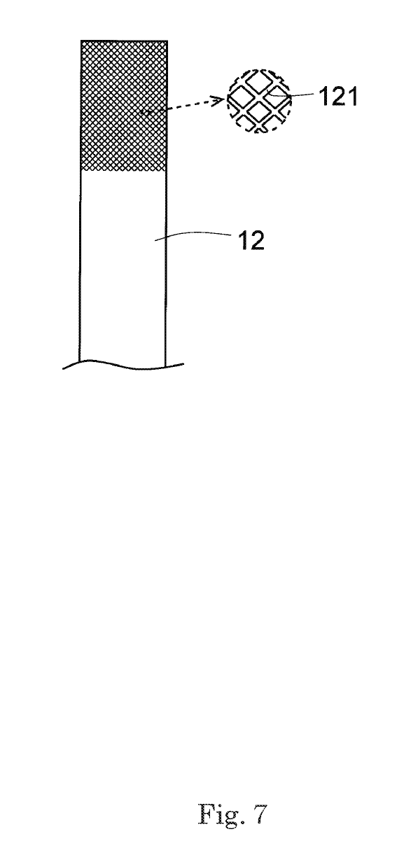

FIG. 7 is a schematic view illustrating a configuration of one end portion of the shaft 12. In FIG. 7, the diagram illustrated on the right of the shaft 12 is a schematic enlarged view of the portion of the shaft 12 that is surrounded by a dashed line. As illustrated in FIG. 7, the shaft 12 includes a plurality of groove portions 121 which are recessed in the radial direction on the outer circumferential surface of the one end portion of the shaft 12 which is fixed to the impeller cylinder portion 112.

In the present embodiment, a plurality of groove portions which diagonally intersect each other in opposite directions with respect to the axial direction are included in the plurality of groove portions 121. Accordingly, minute unevenness is provided on the outer circumferential surface of one end portion of the shaft 12 which is fixed to the impeller cylinder portion 112. In this configuration, since it is possible to insert a portion of the impeller cylinder portion 112 into the groove portions 121 of the shaft 12 at the portion at which the impeller cylinder portion 112 and the shaft 12 are press-fitted, it is possible to firmly fix the shaft 12 to the impeller cylinder portion 112.

It is possible to form the plurality of groove portions 121 which configure the minute unevenness using knurling, for example. The minute unevenness which is configured on the one end portion of the shaft 12 is not limited to the above configuration, and, for example, may be configured by a plurality of groove portions which extend in a direction which is parallel, perpendicular, or inclined in only one direction with respect to the axial direction, for example. In the present embodiment, although the plurality of groove portions 121 are provided in the one end portion of the shaft 12, the groove portions 121 may not be provided.

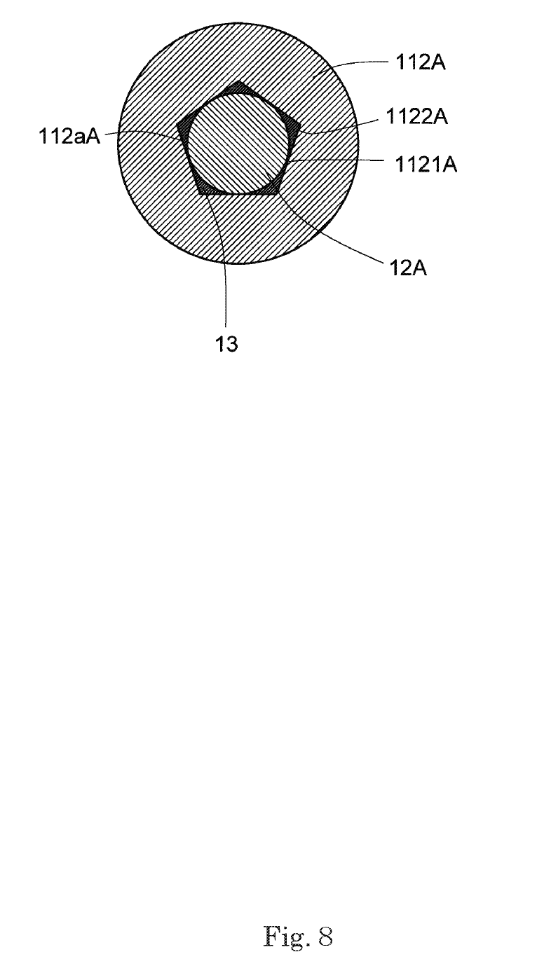

FIG. 8 is a diagram for explaining a first modification example of the vane wheel 1 according to the embodiment of the present disclosure. In detail, FIG. 8 is a lateral sectional view illustrating a relationship between an impeller cylinder portion 112A and a shaft 12A. In the first modification example, an adhesive 13 is disposed between the shaft 12A and second portions 1122A in the radial direction. The adhesive 13 connects the shaft 12A to the impeller cylinder portion 112A. The adhesive 13 may be composed of an epoxy-based resin or the like, for example.

According to the configuration of the modification example, since it is possible to fix the shaft 12A to the impeller cylinder portion 112A using the adhesive 13 in addition to the press-fitting at first portions 1121A, it is possible to firmly fix the shaft 12A to the impeller cylinder portion 112. The adhesive 13 is capable of functioning as a rotation lock which prevents the impeller cylinder portion 112A from rotating with respect to the shaft 12A.

For example, a configuration may be adopted in which the adhesive 13 is disposed between the shaft 12A and the second portions 1122A in the radial direction by applying the adhesive 13 to an inner circumferential surface 112aA of the impeller cylinder portion 112A before the shaft 12A is pressed in. In a configuration in which the adhesive 13 is applied to the inner circumferential surface 112aA of the impeller cylinder portion 112A in a liquid state in advance, it is possible to cause the liquid state adhesive 13 to function as a lubricant during the pressing in of the shaft 12A. Subsequently, it is possible to fix the shaft 12A to the impeller cylinder portion 112A by curing the adhesive 13. As another example, a configuration may be adopted in which the space between the shaft 12A and the second portions 1122A in the radial direction is filled with the adhesive 13 after the shaft 12A is pressed into the impeller cylinder portion 112A.

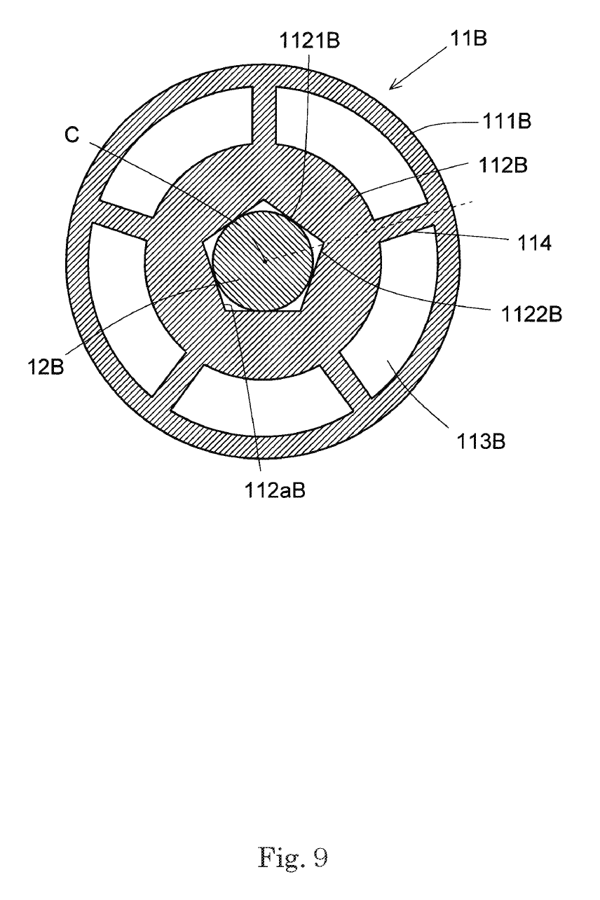

FIG. 9 is a diagram for explaining the second modification example of the vane wheel 1 according to the embodiment of the present disclosure. In detail, FIG. 9 is a lateral sectional view illustrating a relationship between an impeller 11B and a shaft 12B. In the second modification example, the impeller 11B includes a plurality of ribs 114 in addition to an impeller base portion 111B, an impeller cylinder portion 112B, and a gap portion 113B. The plurality of ribs 114 are disposed in the gap portion 113B and connect the impeller cylinder portion 112B to the impeller base portion 111B in the radial direction.

In this modification example, the number of ribs 114 is five. The five ribs 114 are disposed at an equal interval in the circumferential direction. Each of the ribs 114 may be plate-shaped. The ribs 114 are the same member as the impeller base portion 111B and the impeller cylinder portion 112B. According to the configuration of this modification example, it is possible to suppress the spreading of the impeller base portion 111B in the radial direction caused by a centrifugal force of the high-speed rotation using the ribs 114.

The ribs 114 overlap second portions 1122B in the radial direction. In this modification example, each of the ribs 114 overlaps a peak portion of a regular pentagonal inner circumferential surface 112aB of the impeller cylinder portion 112B in the radial direction. However, each of the ribs 114 may overlap the second portions 1122B in the radial direction and may be disposed at a position deviated from the peak portions of the polygon. It is preferable that the ribs 114 do not overlap first portions 1121B in the radial direction.

According to the configuration of this modification example, the ribs 114 overlap portions at which the shaft 12B and the impeller cylinder portion 112B do not contact each other in the radial direction. Therefore, it is possible to suppress the force which is applied from the shaft 12B to the impeller cylinder portion 112B to be transmitted to the impeller base portion 111B along the ribs 114. Therefore, it is possible to prevent the deformation of the vanes which are provided on the impeller base portion 111B.

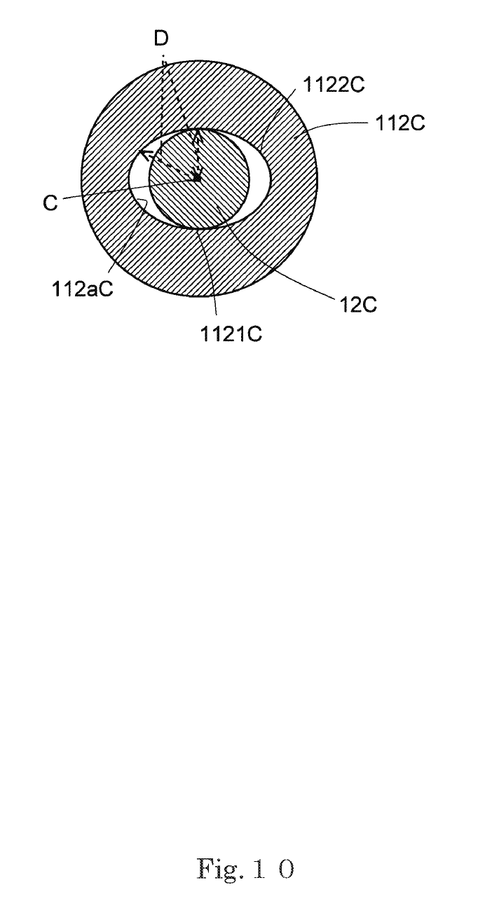

FIG. 10 is a diagram for explaining the third modification example of the vane wheel 1 according to the embodiment of the present disclosure. In detail, FIG. 10 is a lateral sectional view illustrating a relationship between an impeller cylinder portion 112C and a shaft 12C. As illustrated in FIG. 10, an inner circumferential surface 112aC of the impeller cylinder portion 112C is elliptical in plan view from the axial direction. The shapes of the parts to which the shaft 12C is fixed in the inner circumferential surface 112aC of the impeller cylinder portion 112C are the same shape from the top end to the bottom end.

First portions 1121C include portions of the inner circumferential surface 112aC of the impeller cylinder portion 112C at which the radial direction distance D from the center axis C is minimal. In detail, the first portions 1121C include positions which intersect a short axis of the ellipse. Even in the configuration of this modification example, in the circumferential direction, the impeller cylinder portion 112C includes second portions 1122C which are separated from the shaft 12C in the radial direction. Since the portions which are separated from the shaft 12C in the radial direction are easily deformed, in the configuration of this modification example, it is possible to distribute the force which is applied to the impeller cylinder portion 112C from the shaft 12C. In other words, even in this modification example, it is possible to reduce the generation of cracks in the impeller. Even in this modification example, the adhesive may be disposed between the shaft 12C and the second portions 1122C in the radial direction. Accordingly, it is possible to render the fixing of the shaft 12C to the impeller cylinder portion 112C firm.

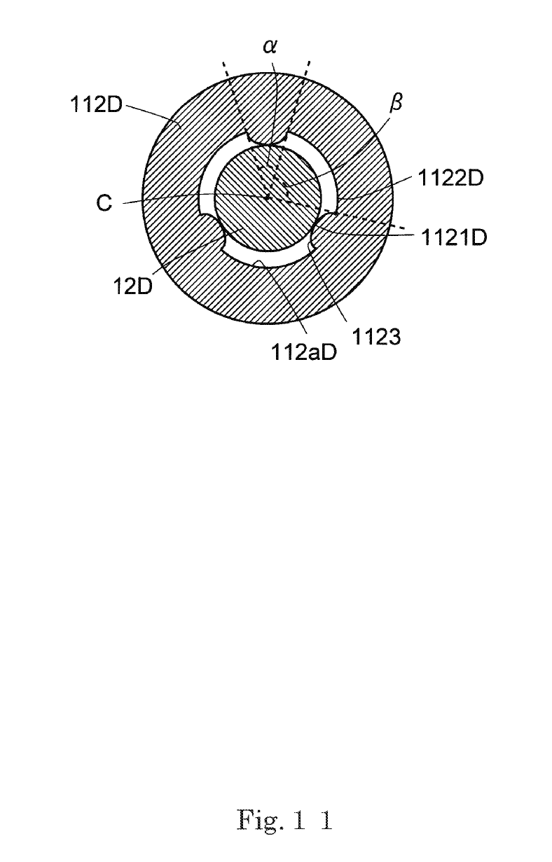

FIG. 11 is a diagram for explaining the fourth modification example of the vane wheel 1 according to the embodiment of the present disclosure. In detail, FIG. 11 is a lateral sectional view illustrating a relationship between an impeller cylinder portion 112D and a shaft 12D. In the fourth modification example, the impeller cylinder portion 112D includes, on an inner circumferential surface 112aD, a plurality of convex portions 1123 which protrude to the inside in the radial direction. In this modification example, the inner circumferential surface 112aD of the impeller cylinder portion 112D is circular in plan view from the axial direction and includes the convex portions 1123 on a portion of the inner circumferential surface 112aD. The plurality of convex portions 1123 are disposed at an equal interval in the circumferential direction. However, the plurality of convex portions 1123 may not be disposed at an equal interval. It is possible to improve the balance during the rotation of the impeller by disposing the plurality of convex portions 1123 at an equal interval. It is possible to equally distribute the force which is applied to the impeller cylinder portion 112D from the shaft 12D.

In this modification example, the number of convex portions 1123 is three. However, the number of the convex portions 1123 may be two or greater than or equal to four. In this modification example, the surface of the convex portion 1123 facing the shaft 12D in the radial direction is a convex surface which protrudes toward the inside in the radial direction. However, the surface of the convex portion 1123 facing the shaft 12D in the radial direction may be a recessed surface which is recessed toward the outside in the radial direction.

First portions 1121D include at least a portion of the surface of the convex portions 1123 facing the shaft 12D in the radial direction. In this modification example, the first portions 1121D include a portion of the surface of the convex portions 1123 facing the shaft 12D in the radial direction. The number of convex portions 1123 is three and the number of the first portions 1121D is three. The shaft 12D is press-fitted by the three first portions 1121D.

Even in the configuration of this modification example, in the circumferential direction, the impeller cylinder portion 112D includes portions which are separated from the shaft 12D in the radial direction. Since the portions which are separated from the shaft 12D in the radial direction are easily deformed, in the configuration of this modification example, it is possible to distribute the force which is applied to the impeller cylinder portion 112D from the shaft 12D. In other words, even in this modification example, it is possible to reduce the generation of cracks in the impeller. Even in this modification example, the adhesive may be disposed between the shaft 12D and second portions 1122D in the radial direction. Accordingly, it is possible to render the fixing of the shaft 12D to the impeller cylinder portion 112D firm.

In the inner circumferential surface 112aD of the impeller cylinder portion 112D, an angle α of the region in which the convex portion 1123 is disposed with respect to the center axis C in the circumferential direction is the same as or smaller than an angle β of the region between two convex portions 1123 which are adjacent in the circumferential direction with respect to the center axis C. In this modification example, the angle α is smaller than the angle β. The region between the two convex portions 1123 which are adjacent in the circumferential direction is a region in which the convex portions 1123 are not disposed. In this configuration, in a case in which the interval between the convex portions 1123 which are adjacent to each other in the circumferential direction is increased in size and a force is applied to the impeller cylinder portion 112D from the shaft 12D, it is possible to secure leeway for the convex portions 1123 to deform. Therefore, for example, during the press-fitting, it is possible to distribute the force which is applied to the impeller cylinder portion 112D from the shaft 12D to reduce the generation of cracks in the impeller.

It is possible to use the present disclosure on a blowing device having a vane wheel and a vacuum cleaner or the like which includes the blowing device, for example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A vane wheel comprising:
a shaft which is disposed along a center axis and is circular in plan view from an axial direction; and
an impeller including an impeller cylinder portion to which one end portion of the shaft in the axial direction is fixed,
wherein the impeller cylinder portion includes, on an inner circumferential surface thereof,
a plurality of first portions which are disposed with an interval in a circumferential direction, and are in contact with the shaft and fix the shaft, and
a plurality of second portions which face the shaft with an interval in a radial direction and each of which is positioned between two of the first portions which are adjacent in the circumferential direction.

2. The vane wheel according to claim 1,
wherein the shaft is press-fitted to the plurality of first portions.

3. The vane wheel according to claim 1,
wherein the shaft includes a plurality of groove portions which are recessed in the radial direction on an outer circumferential surface of the one end portion.

4. The vane wheel according to claim 1,
wherein an adhesive is disposed between the shaft and each of the second portions in the radial direction, and
wherein the adhesive connects the shaft to the impeller cylinder portion.

5. The vane wheel according to claim 1,
wherein the impeller includes
a conical impeller base portion including a plurality of vanes on an outer circumferential surface, and
a gap portion which is positioned between the impeller base portion and the impeller cylinder portion in the radial direction,
wherein the impeller cylinder portion is positioned inside the impeller base portion in the radial direction, and
wherein at least a portion of the one end portion in the axial direction faces the impeller base portion with the gap portion in between.

6. The vane wheel according to claim 1,
wherein the impeller includes
a conical impeller base portion including a plurality of vanes on an outer circumferential surface,
a gap portion which is positioned between the impeller base portion and the impeller cylinder portion in the radial direction, and
a plurality of ribs which are disposed in the gap portion and connect the impeller cylinder portion to the impeller base portion in the radial direction,
wherein the impeller cylinder portion is positioned inside the impeller base portion in the radial direction, and
wherein the ribs overlap the second portions in the radial direction.

7. The vane wheel according to claim 1,
wherein the inner circumferential surface of the impeller cylinder portion is polygonal or elliptical in plan view from the axial direction, and
wherein each of the first portions includes a portion of the inner circumferential surface of the impeller cylinder portion at which a radial direction distance from the center axis is minimal.

8. The vane wheel according to claim 1,
wherein the impeller cylinder portion includes a plurality of convex portions which are disposed on the inner circumferential surface with an interval in the circumferential direction and which protrude to an inside in the radial direction, and
wherein the first portions include at least a portion of a surface of the convex portions facing the shaft in the radial direction.

9. The vane wheel according to claim 8,
wherein, in the inner circumferential surface of the impeller cylinder portion, an angle of a region, in which each of the convex portions is disposed, with respect to the center axis in the circumferential direction is the same as or smaller than an angle of a region between two of the convex portions, which are adjacent in the circumferential direction, with respect to the center axis in the circumferential direction.

10. A blowing device comprising
the vane wheel of claim 1.
